(19) United States
(12) Patent Application Publication
(10) Pub. No.: US 2018/0334772 A1
(43) Pub. Date: Nov. 22, 2018

(54) IMPROVED PROCESS FOR MAKING AN ANTIMICROBIAL COMPOSITION

(71) Applicants: Dow Global Technologies LLC, Midland, MI (US); Rohm and Haas Company, Collegeville, PA (US)

(72) Inventors: David L. Frattarelli, Pottstown, PA (US); Eileen F. Warwick, Lansdale, PA (US); Nicholas P. Mitchell, West Cheater, PA (US); Yunfei Yan, Shanghai (CN)

(21) Appl. No.: 15/777,683

(22) PCT Filed: Dec. 17, 2015
(86) PCT No.: PCT/CN2015/097658

§ 371 Date: May 21, 2018

(51) Int. Cl. D06M 11/83; A01N 59/16; A01N 25/04; D06M 15/263

(52) U.S. Cl. CPC D06M 11/83; A01N 59/16; D06M 2101/06; D06M 15/263; A01N 25/04

(57) ABSTRACT

The present invention relates to a method for preparing a color stable and wash durable treated fabric.

The present invention relates to an improved process for making a color stable and wash durable treated fabric.

Silver ion is attributed as a safe anti-microbial solution for textile applications. Many companies in the textile industry are developing innovative controllable silver ion delivery systems. It is desirable to have a delivery system which will release silver ions when microbes come in contact with the textile products to prevent microbial growth and unpleasant odors. However, it is also desirable to minimize silver release when the textiles are exposed to humid environments and to light as this can contribute to discoloration of textiles treated with silver antimicrobials.

U.S. Pat. No. 7335613 discloses one such formulation where silver is applied to textiles. The cited reference describes an antimicrobial composition comprising a metal complexed with a polymer, wherein the metal is selected from copper, silver, gold, tin, zinc and combinations thereof. It has been discovered that while such compositions are efficacious, textiles treated with these compositions sometimes discolor and do not have adequate wash durability.

Color stability and wash durability are common challenges to the textile industry. Ideally stable fabric color can be achieved with all the silver ions in close association with the polymer backbone. However, in reality, silver ion has been shown to be released under the following situations and then in turn have a negative impact on color stability and wash durability. These scenarios include:
Low pH textile baths which neutralize polymer binding sites altering adsorption and diffusion properties between the polymer and silver ion. Often this will lead to free silver ion deposition on the fabric which can recombine with other available silver ions or anions to produce photo sensitive salts or oxides which in turn lead to discoloration upon drying, light exposure, and humidity exposure.
Highly ionic textile processing water which contains anions (e.g. chloride, bromide, carboxylate, sulfate) and cations (e.g. calcium, magnesium). Anions, due to their favorable equilibrium constants may compete for silver ion to form undesirable photo sensitive silver salts. Cations on the other hand may disrupt silver-polymer affinity to afford unassociated free silver ion.
Extended fabric storage under harsh temperature, light, and humidity may influence availability of free silver ion on fabric. This in turn could lead to the formation of photosensitive salts or by-products.
Lastly, improperly washed fabrics, prior to the addition of silver-polymer composite may result in chemical reactions between standard reducing chemistries used in textile dyeing. Chemistries include sodium hydrosulfide, sodium hydrosulphite, sodium thiosulphate, glucose, and citric acid.
   To meet the color requirements, and manage the issue of color stability, the industry has narrowed application conditions, e.g. reduce the loading level of silver amount on the fabric. This reduction in silver loading can in turn negatively impact the wash durability of the odor control feature.

Thus, the need exists for a process to load silver onto a fabric wherein discoloration of the resultant treated article is reduced and the treated article will have a consistent, durable odor control benefit.

The present invention solves the problem in the art by providing a method for preparing a treated fabric comprising:
i) providing a solution of:
   a) silver ion;
   b) polymer containing metal-ion ligands; and
   c) water
ii) applying the solution to a fabric to create a pre-treated fabric; and iii) applying a fluid containing at least one stabilizing polymer emulsion to the pre-treated fabric to create a treated fabric.

As used herein, “color stable” means a ΔE*ab after weathering which is less than 2 when compared to the untreated control.

As used herein, “fabric” means a woven or nonwoven textile such as cotton, polyester, nylon, lycra, polyolefin and blends thereof.

As used herein, “wash durable means” the treated article provides acceptable antimicrobial efficacy after laundering using industry standard methods such as AATCC Test Method 61 or AATCC Test Method 135 (Colorfastness to

Laundering: Accelerated) followed by AATCC Test Method 100 (Antibacterial Finishes on Textile Materials: Assessment of).

All percentages expressed herein are wt. % or ppm w/w.

According to the present method, a solution comprising silver ion, a polymer and water is provided. Silver ion and water are terms readily known to those of ordinary skill in the art. Polymers useful in the present invention include those which contain metal ion ligands. Suitable polymers containing metal ion ligands are described in U.S. Pat. No. 7,390,774 and U.S. Pat. No. 7,927,379. Suitable metal ion ligands include vinyl imidazole and vinyl pyridine. Silver ion may be present at 10-100 ppm %, alternatively 20-80 ppm, further alternatively 30-50 ppm of the solution. Polymer with metal ion ligands may be present in 0.005-0.1%, alternatively 0.01-0.08%, further alternatively 0.025-0.05%% of the solution. The solution of the present invention has a pH in the range of 4-9 or alternatively 6-8.

This solution of silver ion, polymer, and water is then applied to a fabric to create a pre-treated fabric. The application of solution may be accomplished by any known method in the art. Exhaustion and conventional padding processes are examples of suitable methods that may be used in the present invention.

Following the application of solution, the fabric may then be dried. Conventional drying methods may be used. The fabric is said to be “dry” when the weight of the fabric is equal to its initial weight before treatment. In one embodiment of the present invention, the pre-treated fabric is dry.

Next, a fluid containing at least one stabilizing polymer emulsion is applied to the pre-treated fabric to create a treated fabric. Suitable stabilizing polymer emulsions include acrylic and styrene-acrylic binders. The stabilizing polymer emulsion is diluted in water for application to the textile. The polymer emulsion concentration in water may be 1-60%, alternatively 2-50%, further alternatively 5-45% of the solution. The solution of the stabilizing polymer emulsion is then applied to the pre-treated fabric. Known methods of applying fluids to fabrics may be used to apply the present fluid to the pre-treated fabric. Suitable methods include exhaustion and conventional padding methods. Following the application of solution, the fabric may then be dried. Conventional drying methods may be used.

According to the present invention the stabilizing polymer emulsion immobilizes the silver-polymer complex so to prevent the premature release of silver ion upon storage and use of the treated fabric. The stabilizing polymer emulsion performs this by providing a thin film which does not negatively impact the “hand” or feel of the textile good. This in turn produces a color stable and wash durable treated fabric product with desirable hand, antimicrobial, and odor control properties.

Some embodiments of the present invention will now be described in detail in the following Examples. All fractions and percentages set forth below in the Examples are by weight unless otherwise specified.

### EXAMPLES

### Materials and Methods Used to Prepare Treated Fabric

### Material

| Chemicals | Supplier | Description |
|---|---|---|
| Fabric samples | JSA (Japanese | Standard cotton JIS |
| | Standards Association) | L0803, 100% |
| | | cotton |
| SILVADUR ™ | The Dow Chemical | 1000 ppm silver ion |
| 930 | Company | in this |
| antimicrobial | | silver/polymer |
| | | product |
| RHOPLEX ™ | The Dow Chemical | stabilizer |
| B-15J | Company | |
| crosslinkable | | |
| acrylic binder | | |
| RHOPLEX ™ | The Dow Chemical | stabilizer |
| NW-1845K | Company | |
| styrenated | | |
| acrylic polymer | | |

### Methods:

### Fabric Treatment.

A Lab scale padding machine from Werner Mathis AG (Model: CH-8155 VFM28888) was used to apply finishing chemicals to fabric samples.

First the wet-pick up rate (WPUR) is determined to calculate the concentration of SILVADUR 930 solution needed to achieve a target silver loading on the dried textile. The roller pressure is set to 3 barg initially. Then a 12″ by 16″ swatch of fabric is weighed out. Most fabric swatches will weigh between 10 to 15 grams. Polyester is typically 12 grams and heavy cotton is typically 15 grams. The swatch is soaked in a deionized water bath for 3 to 8 seconds until it has fully absorbed the water. Immediately after, the wet fabric is passed through the spinning rollers at the 3 barg pressure setting. The fabric is then reweighted to determine the increase in weight due to absorption of water. The WPUR is calculated by the difference in the weight of the wet fabric after going through the rollers and the dried fabric weight divided by the dried fabric weight. Polyester fabric typically will weight around 27 grams after and 12 grams before for a calcualted wet pick-up rate of (27-12)/12 or 125%. Cotton typically weighs 15 grams dried and 27 grams after the roller for a calculated wet pick-up rate of (27-15)/15 or 80%. If the wet pick-up rate does not match the desired value the pressure of the padding rollers can be adjusted up or down to achieve the desired values.

Second, the application bath solutions are prepared to treat each textile swatch. The concentration silver in the bath is calculated based on the initial concentrate solution and the wet pick-up rate. The calculation of bath concentration of SILVADUR 930 is calcualted by dividing the target silver level by the active loading in the SILVADUR 930 formulation and then dividing by the wet pick-up rate. For example to target 30 ppm silver on polyester fabric with a 125% wet pick-up rate using SILVADUR 930 with 1000 ppm of silver, would require 30 ppm Ag target/1000 ppm Ag in SILVADUR 930/1.25 WPUR*100%, or 2.4 g SILVADUR 930 into 100 g. On cotton fabric with a 80% wet pick-up rate the calculation would be 30 ppm Ag target/1000 ppm Ag in SILVADUR 930/0.80 WPUR*100%, or 3.75 g SILVADUR 930 into 100 g.

The treatment solution for 30 ppm silver on polyester would be simply formulated by weighing out 2.4 grams of SILVADUR 930 and mixing it into 97.6 grams of deionized water, and for cotton by weighing out 3.75 grams of SILVADUR 930 and mixing into 96.25 grams of deionized water.

Lastly, the treatment of each fabric was carried out in the padding machine using the pressure settings determined above to achieve the desired wet pick-up rate for each fabric swatch. Each silver solution was poured into the trough on the padding machine prior to treatment. Then fabric samples were dipped into silver solutions for 3 to 8 seconds until soaked Immediately, the wet fabric was then passed through the rollers to achieve the desired wet pick-up weights. Then fabrics were placed onto a device that stretches the fabric taught and dried in a convection oven at 150° C. for 2 minutes. For secondary treatments, new baths were prepared with the stabilizing polymer emulsions in water and fabrics dipped in these solutions for 3-8 seconds until soaked, passed through the rollers and dried at 150° C. for 2 minutes.

### Fabric Weathering.

All fabrics were aged in a climate chamber (Model: KBWF 720 climate chamber, Binder Company) to accelerate color change. The 12″ by 16″ treated swatches of fabric were cut in half lengthwise to produce two strips of 6″ by 16″. One stip was used in the climate chamber by first covering half of the sample, or about 6″ by 8″, using a light-proof paper card on both sides and leaving the other have uncovered and exposed. Those strips were hung vertically inside the chamber. The chamber was then set to 30° C. and cycled humidity as follows: 30% relative humidity for 4 hours, 2 hour transition from 30% to 90%, hold at 90% for 4 hours, 2 hour transition from 90% to 30%, and repeated. This weathering cycle was repeated for 3 weeks. The light source was a LUMILUX Cool Daylight (OSRAM L36w/865 lighting bulb) which was kept on during the weathering process.

### Fabric Color Measurement

The color of fabrics after weathering was measured using a Hunterlab Spectrophotometer (Model: Labscan XE) with illumination from a pulsed xenon arc source, a 0 degree illumination angle and a 45 degree viewer angle with a 13 mm (0.5″) measuring area. Measurements were performed on 2 layers of the experimental fabrics using standard white tile as the backing. The untreated standard cotton was used as control fabric to which all experimental fabric samples were compared to evaluate total color change (ΔE*ab). Larger ΔE*ab corresponds with more color change on the fabrics. The calculation of ΔE*ab is based on the measurements of L, a, and b which describe the coordinate space of light/dark, red/green, and blue/yellow. The ΔE*ab value is calculated as the square root of the sum of square differences between the measured sample values and the control sample.

$$Δ {E}_{ab}^{*} = \sqrt{{( L \text{?} - L \text{?} )}^{2} + {( a \text{?} - a \text{?} )}^{2} + {( b \text{?} - b \text{?} )}^{2}}$$

$$\text{?} \text{indicates text missing or illegible when filed}$$

Where the subscript 0 represents the control sample values and i represents the individual sample measurement. Each fabric swatch was measured a three locations and averages of L, a, and b values were used on the ΔE*ab calculations.

### Example 1

### Two-Step Process for Improving Discoloration on Cotton Fabrics Using a Crosslinkable Acrylic Polymer (RHOPLEX B-15J)

| % | % | One Step | Two Step | Improvement |
|---|---|---|---|---|
| Silvadur | RHOPLEX | Process | Process | with Two |
| 930 | B-15J | ΔE*ab | ΔE*ab | Step |
| 3 | 10.9 | 4.35 ± 0.23 | 1.59 ± 0.07 | Y |
| 5 | 10.9 | 5.90 ± 0.06 | 2.24 ± 0.07 | Y |
| 5 | 2.7 | 1.02 ± 0.1 | 0.94 ± 0.07 | N |
| 5 | 5.4 | 1.87 ± 0.07 | 1.33 ± 0.03 | Y |
| 5 | 21.8 | 5.98 ± 0.06 | 2.36 ± 0.03 | Y |
| 5 | 43.8 | 6.82 ± 0.3 | 3.33 ± 0.15 | Y |

### Example 2

### Two-Step Process for Improving Discoloration on Cotton Fabrics Using a Styrenated Acrylic Polymer (RHOPLEX NW-1845K)

| | % | One Step | Two Step | Improvement |
|---|---|---|---|---|
| % Silvadur | RHOPLEX | Process | Process | with Two |
| 930 | NW-1845 | ΔE*ab | ΔE*ab | Step |
| 3 | 11.4 | 3.48 ± 0.12 | 1.49 ± 0.08 | Y |
| 5 | 11.4 | 6.13 ± 0.12 | 2.51 ± 0.13 | Y |
| 5 | 5.7 | 1.46 ± 0.12 | 0.79 ± 0.03 | Y |
| 5 | 22.6 | 4.18 ± 0.2 | 1.12 ± 0.06 | Y |

### Improved Process for Making an Antimicrobial Composition

The present invention relates to an improved process for making a color stable and wash durable treated fabric.

Silver ion is attributed as a safe anti-microbial solution for textile applications. Many companies in the textile industry are developing innovative controllable silver ion delivery systems. It is desirable to have a delivery system which will release silver ions when microbes come in contact with the textile products to prevent microbial growth and unpleasant odors. However, it is also desirable to minimize silver release when the textiles are exposed to humid environments and to light as this can contribute to discoloration of textiles treated with silver antimicrobials.

U.S. Pat. No. 7,335,613 discloses one such formulation where silver is applied to textiles. The cited reference describes an antimicrobial composition comprising a metal complexed with a polymer, wherein the metal is selected from copper, silver, gold, tin, zinc and combinations thereof. It has been discovered that while such compositions are efficacious, textiles treated with these compositions sometimes discolor and do not have adequate wash durability.

Color stability and wash durability are common challenges to the textile industry. Ideally stable fabric color can be achieved with all the silver ions in close association with the polymer backbone. However, in reality, silver ion has been shown to be released under the following situations and then in turn have a negative impact on color stability and wash durability. These scenarios include:
Low pH textile baths which neutralize polymer binding sites altering adsorption and diffusion properties between the polymer and silver ion. Often this will lead to free silver ion deposition on the fabric which can recombine with other available silver ions or anions to produce photo sensitive salts or oxides which in turn lead to discoloration upon drying, light exposure, and humidity exposure.
Highly ionic textile processing water which contains anions (e.g. chloride, bromide, carboxylate, sulfate) and cations (e.g. calcium, magnesium). Anions, due to their favorable equilibrium constants may compete for silver ion to form undesirable photo sensitive silver salts. Cations on the other hand may disrupt silver-polymer affinity to afford unassociated free silver ion.
Extended fabric storage under harsh temperature, light, and humidity may influence availability of free silver ion on fabric. This in turn could lead to the formation of photosensitive salts or by-products.
Lastly, improperly washed fabrics, prior to the addition of silver-polymer composite may result in chemical reactions between standard reducing chemistries used in textile dyeing. Chemistries include sodium hydrosulfide, sodium hydrosulphite, sodium thiosulphate, glucose, and citric acid.
   To meet the color requirements, and manage the issue of color stability, the industry has narrowed application conditions, e.g. reduce the loading level of silver amount on the fabric. This reduction in silver loading can in turn negatively impact the wash durability of the odor control feature.

Thus, the need exists for a process to load silver onto a fabric wherein discoloration of the resultant treated article is reduced and the treated article will have a consistent, durable odor control benefit.

The present invention solves the problem in the art by providing a method for preparing a treated fabric comprising:
i) providing a solution of:
   a) silver ion;
   b) polymer containing metal-ion ligands; and
   c) water
ii) applying the solution to a fabric to create a pre-treated fabric; and
iii) applying a fluid containing at least one stabilizing polymer emulsion to the pre-treated fabric to create a treated fabric.
As used herein, “color stable” means a ΔE*ab after weathering which is less than 2 when compared to the untreated control.

As used herein, “fabric” means a woven or nonwoven textile such as cotton, polyester, nylon, lycra, polyolefin and blends thereof.

As used herein, “wash durable means” the treated article provides acceptable antimicrobial efficacy after laundering using industry standard methods such as AATCC Test Method 61 or AATCC Test Method 135 (Colorfastness to

Laundering: Accelerated) followed by AATCC Test Method 100 (Antibacterial Finishes on Textile Materials: Assessment of).

All percentages expressed herein are wt. % or ppm w/w.

According to the present method, a solution comprising silver ion, a polymer and water is provided. Silver ion and water are terms readily known to those of ordinary skill in the art. Polymers useful in the present invention include those which contain metal ion ligands. Suitable polymers containing metal ion ligands are described in U.S. Pat. No. 7,390,774 and U.S. Pat. N o. 7,927,379. Suitable metal ion ligands include vinyl imidazole and vinyl pyridine. Silver ion may be present at 10-100 ppm %, alternatively 20-80 ppm, further alternatively 30-50 ppm of the solution. Polymer with metal ion ligands may be present in 0.005-0.1%, alternatively 0.01-0.08%, further alternatively 0.025-0.05%% of the solution. The solution of the present invention has a pH in the range of 4-9 or alternatively 6-8.

This solution of silver ion, polymer, and water is then applied to a fabric to create a pre-treated fabric. The application of solution may be accomplished by any known method in the art. Exhaustion and conventional padding processes are examples of suitable methods that may be used in the present invention.

Following the application of solution, the fabric may then be dried. Conventional drying methods may be used. The fabric is said to be “dry” when the weight of the fabric is equal to its initial weight before treatment. In one embodiment of the present invention, the pre-treated fabric is dry.

Next, a fluid containing at least one stabilizing polymer emulsion is applied to the pre-treated fabric to create a treated fabric. Suitable stabilizing polymer emulsions include acrylic and styrene-acrylic binders. The stabilizing polymer emulsion is diluted in water for application to the textile. The polymer emulsion concentration in water may be 1-60%, alternatively 2-50%, further alternatively 5-45% of the solution. The solution of the stabilizing polymer emulsion is then applied to the pre-treated fabric. Known methods of applying fluids to fabrics may be used to apply the present fluid to the pre-treated fabric. Suitable methods include exhaustion and conventional padding methods. Following the application of solution, the fabric may then be dried. Conventional drying methods may be used.

According to the present invention the stabilizing polymer emulsion immobilizes the silver-polymer complex so to prevent the premature release of silver ion upon storage and use of the treated fabric. The stabilizing polymer emulsion performs this by providing a thin film which does not negatively impact the “hand” or feel of the textile good. This in turn produces a color stable and wash durable treated fabric product with desirable hand, antimicrobial, and odor control properties.

Some embodiments of the present invention will now be described in detail in the following Examples. All fractions and percentages set forth below in the Examples are by weight unless otherwise specified.

### EXAMPLES

### Materials and Methods Used to Prepare Treated Fabric

### Materials:

| Chemicals | Supplier | Description |
|---|---|---|
| Fabric samples | JSA (Japanese | Standard cotton JIS |
| | Standards Association) | L0803, 100% |
| | | cotton |
| SILVADUR ™ | The Dow Chemical | 1000 ppm silver ion |
| 930 | Company | in this |
| antimicrobial | | silver/polymer |
| | | product |
| RHOPLEX ™ | The Dow Chemical | stabilizer |
| B-15J | Company | |
| crosslinkable | | |
| acrylic binder | | |
| RHOPLEX ™ | The Dow Chemical | stabilizer |
| NW-1845K | Company | |
| styrenated | | |
| acrylic polymer | | |

### Methods:

### Fabric Treatment.

A Lab scale padding machine from Werner Mathis AG (Model: CH-8155 VFM28888) was used to apply finishing chemicals to fabric samples.

First the wet-pick up rate (WPUR) is determined to calculate the concentration of SILVADUR 930 solution needed to achieve a target silver loading on the dried textile. The roller pressure is set to 3 barg initially. Then a 12″ by 16″ swatch of fabric is weighed out. Most fabric swatches will weigh between 10 to 15 grams Polyester is typically 12 grams and heavy cotton is typically 15 grams The swatch is soaked in a deionized water bath for 3 to 8 seconds until it has fully absorbed the water. Immediately after, the wet fabric is passed through the spinning rollers at the 3 barg pressure setting. The fabric is then reweighted to determine the increase in weight due to absorption of water. The WPUR is calculated by the difference in the weight of the wet fabric after going through the rollers and the dried fabric weight divided by the dried fabric weight. Polyester fabric typically will weight around 27 grams after and 12 grams before for a calcualted wet pick-up rate of (27-12)/12 or 125%. Cotton typically weighs 15 grams dried and 27 grams after the roller for a calculated wet pick-up rate of (27-15)/15 or 80%. If the wet pick-up rate does not match the desired value the pressure of the padding rollers can be adjusted up or down to achieve the desired values.

Second, the application bath solutions are prepared to treat each textile swatch. The concentration silver in the bath is calculated based on the initial concentrate solution and the wet pick-up rate. The calculation of bath concentration of SILVADUR 930 is calcualted by dividing the target silver level by the active loading in the SILVADUR 930 formulation and then dividing by the wet pick-up rate. For example to target 30 ppm silver on polyester fabric with a 125% wet pick-up rate using SILVADUR 930 with 1000 ppm of silver, would require 30 ppm Ag target/1000 ppm Ag in SILVADUR 930/1.25 WPUR*100%, or 2.4g SILVADUR 930 into 100 g. On cotton fabric with a 80% wet pick-up rate the calculation would be 30 ppm Ag target/1000 ppm Ag in SILVADUR 930/0.80 WPUR*100%, or 3.75 g SILVADUR 930 into 100 g.

The treatment solution for 30 ppm silver on polyester would be simply formulated by weighing out 2.4 grams of SILVADUR 930 and mixing it into 97.6 grams of deionized water, and for cotton by weighing out 3.75 grams of SILVADUR 930 and mixing into 96.25 grams of deionized water. Lastly, the treatment of each fabric was carried out in the padding machine using the pressure settings determined above to achieve the desired wet pick-up rate for each fabric swatch. Each silver solution was poured into the trough on the padding machine prior to treatment. Then fabric samples were dipped into silver solutions for 3 to 8 seconds until soaked. Immediately, the wet fabric was then passed through the rollers to achieve the desired wet pick-up weights. Then fabrics were placed onto a device that stretches the fabric taught and dried in a convection oven at 150° C. for 2 minutes. For secondary treatments, new baths were prepared with the stabilizing polymer emulsions in water and fabrics dipped in these solutions for 3-8 seconds until soaked, passed through the rollers and dried at 150° C. for 2 minutes.

### Fabric Weathering.

All fabrics were aged in a climate chamber (Model: KBWF 720 climate chamber, Binder Company) to accelerate color change. The 12″ by 16″ treated swatches of fabric were cut in half lengthwise to produce two strips of 6″ by 16″. One stip was used in the climate chamber by first covering half of the sample, or about 6″ by 8″, using a light-proof paper card on both sides and leaving the other have uncovered and exposed. Those strips were hung vertically inside the chamber. The chamber was then set to 30° C. and cycled humidity as follows: 30% relative humidity for 4hours, 2 hour transition from 30% to 90%, hold at 90% for 4 hours, 2 hour transition from 90% to 30%, and repeated. This weathering cycle was repeated for 3 weeks. The light source was a LUMILUX Cool Daylight (OSRAM L36w/865 lighting bulb) which was kept on during the weathering process.

### Fabric Color Measurement

The color of fabrics after weathering was measured using a Hunterlab Spectrophotometer (Model: Labscan XE) with illumination from a pulsed xenon arc source, a 0 degree illumination angle and a 45 degree viewer angle with a 13 mm (0.5″) measuring area. Measurements were performed on 2 layers of the experimental fabrics using standard white tile as the backing. The untreated standard cotton was used as control fabric to which all experimental fabric samples were compared to evaluate total color change (ΔE*ab). Larger ΔE*ab corresponds with more color change on the fabrics. The calculation of ΔE*ab is based on the measurements of L, a, and b which desribe the coordinate space of light/dark, red/green, and blue/yellow. The ΔE*ab value is calculated as the square root of the sum of square differences between the measured sample values and the control sample.

$$Δ {E}_{ab}^{*} = \sqrt{{( L \text{?} - L \text{?} )}^{2} + {( a \text{?} - a \text{?} )}^{2} + {( b \text{?} - b \text{?} )}^{2}}$$

$$\text{?} \text{indicates text missing or illegible when filed}$$

Where the subscript 0 represents the control sample values and i represents the individual sample measurement. Each fabric swatch was measured a three locations and averages of L, a, and b values were used on the ΔE*ab calculations.

### Example 1

### Two-Step Process for Improving Discoloration on Cotton Fabrics Using a Crosslinkable Acrylic Polymer (RHOPLEX B-15J)

| % | % | One Step | Two Step | Improvement |
|---|---|---|---|---|
| Silvadur | RHOPLEX | Process | Process | with Two |
| 930 | B-15J | ΔE*ab | ΔE*ab | Step |
| 3 | 10.9 | 4.35 ± 0.23 | 1.59 ± 0.07 | Y |
| 5 | 10.9 | 5.90 ± 0.06 | 2.24 ± 0.07 | Y |
| 5 | 2.7 | 1.02 ± 0.1 | 0.94 ± 0.07 | N |
| 5 | 5.4 | 1.87 ± 0.07 | 1.33 ± 0.03 | Y |
| 5 | 21.8 | 5.98 ± 0.06 | 2.36 ± 0.03 | Y |
| 5 | 43.8 | 6.82 ± 0.3 | 3.33 ± 0.15 | Y |

### Example 2

### Two-Step Process for Improving Discoloration on Cotton Fabrics Using aC Styrenated Acrylic Polymer (RHOPLEX NW-1845K)

| % | % | One Step | Two Step | Improvement |
|---|---|---|---|---|
| Silvadur | RHOPLEX | Process | Process | with Two |
| 930 | NW-1845 | ΔE*ab | ΔE*ab | Step |
| 3 | 11.4 | 3.48 ± 0.12 | 1.49 ± 0.08 | Y |
| 5 | 11.4 | 6.13 ± 0.12 | 2.51 ± 0.13 | Y |
| 5 | 5.7 | 1.46 ± 0.12 | 0.79 ± 0.03 | Y |
| 5 | 22.6 | 4.18 ± 0.2 | 1.12 ± 0.06 | Y |

We claim:

1. A method for preparing a treated fabric comprising:
i) providing a solution of:
a) silver ion;
b) polymer containing metal ion ligands; and
c) water
ii) applying the solution to a fabric to create a pre-treated fabric; and
iii) applying a fluid containing at least one stabilizing polymer emulsion to the pre-treated fabric to create a treated fabric.

2. The method of claim 1 wherein the stabilizing polymer emulsion is a styrenated acrylic polymer.

3. The method of claim 1 wherein the stabilizing polymer emulsion is a crosslinkable acrylic polymer.

4. The method of claim 1 wherein the fabric is cotton.

5. The method of claim 1 wherein the pre-treated fabric is dried.
